(19) United States
(12) Patent Application Publication
(10) Pub. No.: US 2010/0134921 A1
(43) Pub. Date: Jun. 3, 2010

(54) STORAGE DEVICE

(75) Inventor: Hiroshi Suzuki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/569,626

(22) Filed: Sep. 29, 2009

(30) Foreign Application Priority Data
Nov. 28, 2008 (JP) 2008-304467

(51) Int. Cl. G11B 5/17

(52) U.S. Cl. 360/123.01; G9B/5.05

(57) ABSTRACT

According to one embodiment, a storage device includes a coil supporting arm, an actuator, and a magnetic circuit. The coil supporting arm includes a flat coil and a coil supporting module that is coupled with the inner circumference of the flat coil to support the flat coil. The actuator holds a head at one end and is provided with the coil supporting arm at another end. The magnetic circuit is arranged near the flat coil to drive the actuator.

### CROSS-REFERENCE TO RELATED APPLICATIONS

This application is based upon and claims the benefit of priority from Japanese Patent Application No. 2008-304467, filed Nov. 28, 2008, the entire contents of which are incorporated herein by reference.

### BACKGROUND

1. Field

One embodiment of the invention relates to a storage device.

2. Description of the Related Art

In the field of computers, a huge amount of information is always handled, and hard disk drives (HDD) are used as storage devices that record and reproduce such huge amount of information. An HDD is provided with a storage medium such as, for example, a magnetic disk and a head that records and reproduces information with respect to the magnetic disk. In the HDD, the head is fixed to an end of the actuator arm that moves along a disk surface. Positioning of the head with respect to the magnetic disk is performed by the movement of the actuator arm.

A voice coil motor has been used to move an actuator arm in an HDD (see, for example, Japanese Patent Application Publication (KOKAI) No. H7-201141, Japanese Patent Application Publication (KOKAI) No. H11-328890, Japanese Patent Application Publication (KOKAI) No. 2006-179117, and Japanese Patent Application Publication (KOKAI) No. 2006-286053). The voice coil motor has a configuration such that a flat coil wound within a surface along the moving surface of the actuator arm that moves along a disk surface is arranged in a predetermined magnetic field. When an electric current flows through the flat coil, a driving force according to the Fleming's left-hand rule acts on the flat coil, and the actuator arm is driven by the driving force.

In an HDD having a voice coil motor, a flat coil vibrates during the movement of the actuator arm. Therefore, there are cases that positioning accuracy of the head with respect to a magnetic disk decreases due to the vibration.

An HDD is exemplified as a storage device to explain a case that the positioning accuracy of a magnetic head decreases. However, such case can occur not only in HDDs but also in a storage device of a type moving a head with respect to a magnetic medium by a voice coil motor, such as a storage device that optically records and reproduces information and a storage device of a type in which a portable storage medium is externally inserted.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a hard disk drive (HDD) as a comparative example;

FIGS. 2A to 2C are exemplary three orthographic views of an actuator in the comparative example;

FIG. 3 is an exemplary diagram of an HDD as a storage medium according to a first embodiment of the invention;

FIGS. 4A to 4C are exemplary three orthographic views of an actuator in the first embodiment;

FIG. 5 is an exemplary enlarged view of the surroundings of a latch magnet and a magnet holding module illustrated in FIG. 3 in the first embodiment; and

FIGS. 6A to 6C are exemplary three orthographic views of a coil supporting module with an actuator according to a second embodiment of the invention.

### DETAILED DESCRIPTION

Various embodiments according to the invention will be described hereinafter with reference to the accompanying drawings. In general, according to one embodiment of the invention, a storage device comprises a coil supporting arm, an actuator, and a magnetic circuit. The coil supporting arm includes a flat coil and a coil supporting module configured to be coupled with the inner circumference of the flat coil to support the flat coil. The actuator is configured to hold a head at one end and be provided with the coil supporting arm at another end. The magnetic circuit is arranged near the flat coil, and is configured to drive the actuator.

A comparative example is explained first.

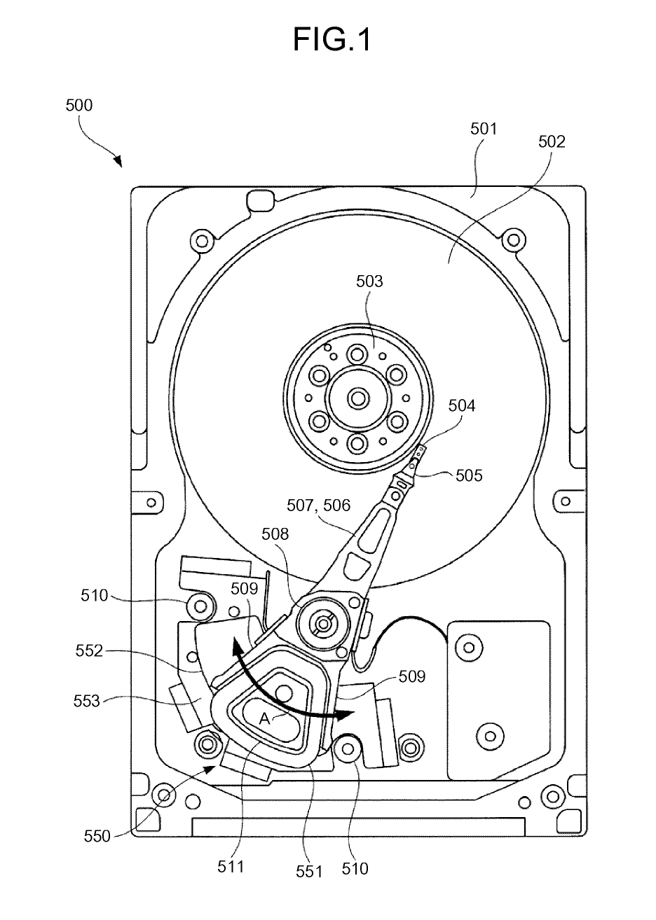

FIG. 1 is a diagram of an HDD of the comparative example to be compared with a storage medium according to an embodiment of the invention.

An HDD 500 illustrated in FIG. 1 comprises a housing 501. The housing 501 houses a plurality of disc-like storage media, i.e., magnetic disks 502, on which information is magnetically recorded and reproduced. The magnetic disks 502 are stacked in the depth direction in FIG. 1 and rotatable around a disk shaft 503.

A magnetic head 504 records and reproduces information with respect to both sides of the magnetic disk 502. In the HDD 500, the magnetic head 504 is provided one each with respect to the both sides of the magnetic disk 502. The magnetic head 504 is held at an end of a suspension 505, and the suspension 505 is fixed to each end of a plurality of actuator arms 506 that move along a surface and a rear face of the magnetic disk 502.

The actuator arms 506 are integrated together to constitute an actuator 507. The actuator 507 is accommodated in the housing 501 rotatably around an actuator shaft 508. Each of the actuator arms 506 moves along the surface of the magnetic disk 502 due to the rotation of the actuator 507 around the actuator shaft 508.

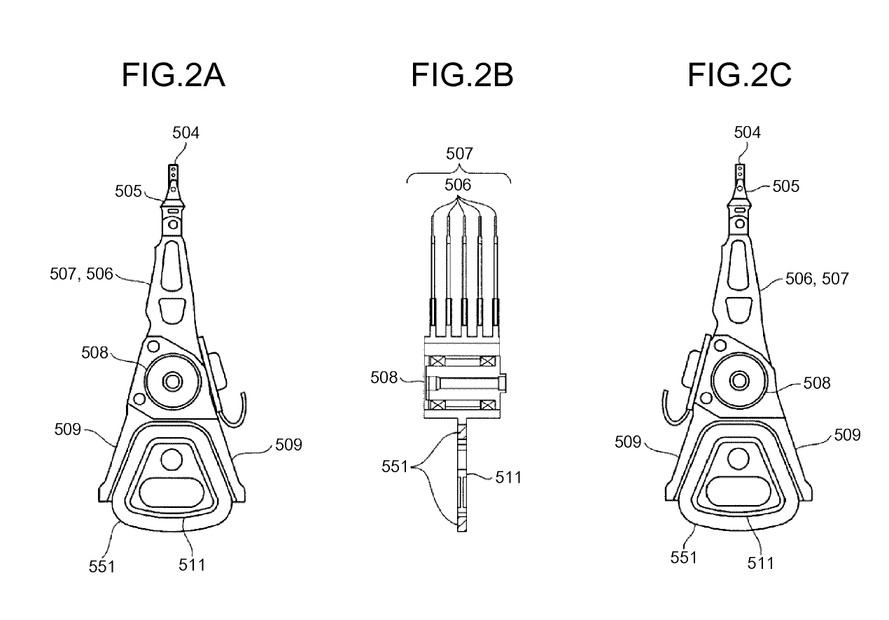

FIGS. 2A to 2C are three orthographic views of the actuator 507.

FIG. 2A is a top view of the actuator 507 as viewed from the same side as in FIG. 1. FIG. 2B is a sectional view of the actuator 507 in a longitudinal direction. FIG. 2C is a bottom view of the actuator 507 as viewed from a side opposite to FIG. 1. While FIGS. 2A and 2C illustrate the magnetic head 504 and the suspension 505 illustrated in FIG. 1, those are omitted in FIG. 2B.

The explanation of the HDD 500 illustrated in FIG. 1 is continued also referring to FIGS. 2A to 2C.

In the HDD 500, the actuator 507 is rotated by a voice coil motor 550 described below.

The voice coil motor 550 comprises a flat coil 551 wound within a surface along the rotating surface of the actuator arm 506, a magnet 552 that applies a magnetic field to the flat coil 551 in a direction perpendicular to the rotating surface, and a yoke 553 fixed to the magnet 552 and functioning as a magnetic path, through which a magnetic field from the magnet 552 passes.

In the voice coil motor 550, the magnet 552 and the yoke 553 are arranged to sandwich the flat coil 551 therebetween in a direction perpendicular to the rotating surface. In FIG. 1, however, the voice coil motor 550 is illustrated with the yoke 553 and the magnet 552 on a top side covering the flat coil 551 from a side opposite to a bottom side of the housing 501 being removed so that an inner structure of the voice coil motor 550 can be seen. That is, in FIG. 1, among the yokes 553 and the magnets 552 constituting the voice coil motor 550, only the yoke 553 and the magnet 552 on the bottom side fixed to the bottom of the housing 501 are illustrated.

In the voice coil motor 550, when an electric current flows to the flat coil 551, a driving force in a direction indicated by arrow A in FIG. 1 within the surface along the rotating surface acts on the flat coil 551, according to the Fleming's left-hand rule.

A coil supporting arm 509 having a bifurcate shape protrudes along an outer circumference of the flat coil 551 from an end of the actuator 507 opposite to the end on a side of the suspension 505 with the actuator shaft 508 therebetween. The outer circumference of the flat coil 551 is bonded and fixed to an inner face of the coil supporting arm 509.

Accordingly, the driving force generated by the flat coil 551 is transmitted to the actuator 507 via the coil supporting arm 509, so that the actuator 507 rotates around the actuator shaft 508.

In the HDD 500 illustrated in FIG. 1, the rotation of the actuator 507 is limited by an actuator stopper 510 so that the movement of the magnetic head 504 along the disk surface is limited within an information recording range in the magnetic disk 502.

The actuator stopper 510 is provided in two positions described below with the coil supporting arm 509 therebetween in a rotating direction of the coil supporting arm 509 that rotates together with the actuator 507. That is, the two positions are a position at which the coil supporting arm 509 abuts against the actuator stopper 510 when the actuator 507 rotates until the magnetic head 504 reaches the innermost information recording range, and a position at which the coil supporting arm 509 abuts against the actuator stopper 510 when the actuator 507 rotates until the magnetic head 504 reaches the outermost information recording range. Accordingly, a movable range of the coil supporting arm 509 is limited within a range between the actuator stoppers 510. As a result, the rotation of the actuator 507 is limited within a rotation range corresponding to the movement of the magnetic head 504 in the information recording range on the magnetic disk 502.

Further, a coil bobbin 511 is fitted in the inside of the flat coil 551 to increase the rigidity of the flat coil 551. An outer circumference of the coil bobbin 511 is bonded and fixed to an inner circumference of the flat coil 551.

The HDD 500 illustrated in FIGS. 1 and 2A to 2C has problems relating to the positioning accuracy of the magnetic head 504 with respect to the magnetic disk 502 due to the configuration of the voice coil motor 550. Such problems are described below.

In the voice coil motor 550, the magnetic field is basically applied to the flat coil 551 in a direction perpendicular to the rotating surface, and thus the driving force along the rotating surface acts on the flat coil 551 according to the Fleming's left-hand rule. However, strictly speaking, the magnetic field applied to the flat coil 551 often comprises magnetic-field components parallel to the rotating surface. The magnetic-field components generate a driving force that vibrates the flat coil 551 in a direction twisted around a central axis of the flat coil 551 along a longitudinal direction of the actuator 507.

In the voice coil motor 550, the coil supporting arm 509 bifurcates and extends along the outer circumference of the flat coil 551 in a direction away from a centerline of the actuator 507 in a longitudinal direction. Therefore, a moment around the centerline of the actuator 507 in the longitudinal direction in the coil supporting arm 509 is large. As a result, when the driving force that vibrates the flat coil 551 is transmitted to the coil supporting arm 509, the coil supporting arm 509 as well as the entire actuator 507 largely vibrates due to the large moment. Such a vibration decreases the positioning accuracy of the magnetic head 504 with respect to the magnetic disk 502. Further, because the large moment in the coil supporting arm 509 causes large inertia with respect to the vibration, once the vibration is generated, it does not easily attenuate, and thus the decrease of the positioning accuracy of the magnetic head 504 continues for a long time.

In the HDD 500, the rotation of the actuator 507 driven by the voice coil motor 550 is limited by the actuator stoppers 510 with the coil supporting arm 509 therebetween. In this configuration, the coil supporting arm 509 collides with the actuator stopper 510, and the collision vibrates the coil supporting arm 509. The vibration due to the collision between the coil supporting arm 509 and the actuator stopper 510 also causes decrease of the positioning accuracy of the magnetic head 504 for a long time due to the large moment and large inertia in the coil supporting arm 509.

In the voice coil motor 550, the rigidity of the flat coil 551 itself is increased because the coil bobbin 511 is fitted in and bonded and fixed to the inner circumference of the flat coil 551. According to such a configuration, the vibration due to the driving force acting on the flat coil 551 and vibration due to the collision between the coil supporting arm 509 and the actuator stopper 510 are suppressed to some extent. However, in this configuration, the coil bobbin 511 needs to be manufactured as a separate component, which is disadvantageous in view of manufacturing costs.

Further, it can be considered to suppress the vibration of the flat coil 551 and vibration due to the collision with the actuator stopper 510 by increasing a thickness of the coil supporting arm 509 to increase the rigidity of the coil supporting arm 509. However, a limitation on a mounting space in the HDD 500 and increase of a mass of the coil supporting arm 509 cause increase of inertia, and thus there is a limitation in increasing the rigidity of the coil supporting arm 509.

Explanations of the comparative example areas above. Next, a storage medium according to first and second embodiments of the invention is explained.

The first embodiment is explained.

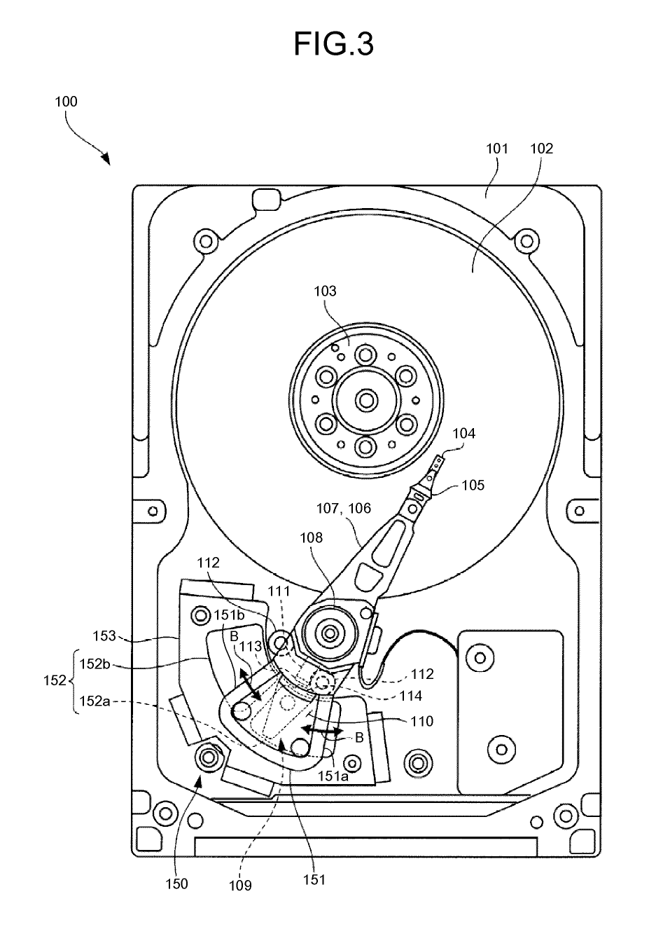

FIG. 3 is a diagram of a hard disk drive (HDD) as a storage medium according to the first embodiment. With reference to FIG. 3, a basic mode of the first embodiment is described below.

An HDD 100 illustrated in FIG. 3 comprises a housing 101. The housing 101 houses a plurality of disc-like storage media, i.e., magnetic disks 102, on which information is magnetically recorded and reproduced. The magnetic disks 102 are stacked in the depth direction in FIG. 3 and rotatable around a disk shaft 103.

A magnetic head 104 records and reproduces information with respect to both sides of each of the magnetic disk 102. In the HDD 100, the magnetic head 104 is provided one each with respect to the both sides of each of the magnetic disk 102. The magnetic head 104 is held at an end of a suspension 105, and the suspension 105 is fixed to each end of a plurality of actuator arms 106 that move along a surface and a rear face of each of the magnetic disk 102.

The magnetic head 104 is an example of the head in the basic mode.

The actuator arms 106 are integrated together to constitute an actuator 107. The actuator 107 is accommodated in the housing 101 rotatably around an actuator shaft 108. A combination of the actuator 107 and the suspension 105 corresponds to an example of the actuator in the basic mode.

Each of the actuator arms 106 moves along a surface and a rear face of each of the magnetic disk 102 due to the rotation of the actuator 107 around the actuator shaft 108.

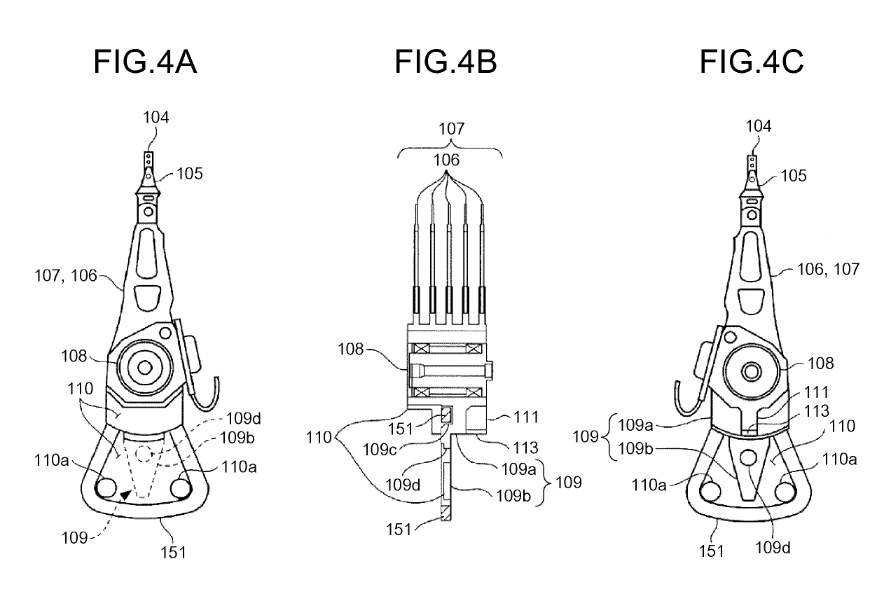

FIGS. 4A to 4C are three orthographic views of the actuator.

FIG. 4A is a top view of the actuator 107 as viewed from the same side as in FIG. 3. FIG. 4B is a sectional view of the actuator 107 in a longitudinal direction. FIG. 4C is a bottom view of the actuator 107 as viewed from a side opposite to FIG. 3. While FIGS. 4A and 4C illustrate the magnetic head 104 and the suspension 105 illustrated in FIG. 3, those are omitted in FIG. 4C.

The explanation of the HDD 100 illustrated in FIG. 3 is continued also referring to FIGS. 4A to 4C.

In the HDD 100, the actuator 107 is rotated by a voice coil motor 150 described below.

The voice coil motor 150 is configured by a flat coil 151 wound within a surface along the rotating surface of the actuator arm 106, a magnet 152 that applies a magnetic field to the flat coil 151 in a direction perpendicular to the rotating surface, and a yoke 153 fixed to the magnet 152 and functioning as a magnetic path, through which the magnetic field from the magnet 152 passes. The flat coil 151 corresponds to an example of the flat coil in the basic mode, and a combination of the magnet 152 and the yoke 153 corresponds to an example of a magnetic circuit in the basic mode.

As for the magnet 152, two kinds of magnets, that is, a first magnet 152a that applies the magnetic field to a coil part 151a of the flat coil 151 on the right in FIG. 3, and a second magnet 152b that applies the magnetic field to a coil part 151b of the flat coil 151 on the left in FIG. 3 are provided. These two kinds of magnets 152a and 152b have an opposite polarity to each other, and apply a magnetic field opposite to each other to each of the two coil parts 151a and 151b.

In the voice coil motor 150, the magnet 152 and the yoke 153 are arranged to sandwich the flat coil 151 therebetween in a direction perpendicular to the rotating surface. In FIG. 3, however, the voice coil motor 150 is illustrated with the yoke 153 and the magnet 152 on a top side covering the flat coil 151 from a side opposite to a bottom side of the housing 101 being removed, so that an inner structure of the voice coil motor 150 can be seen. That is, in FIG. 3, among the yokes 153 and the magnets 152 constituting the voice coil motor 150, only the yoke 153 and the magnet 152 on the bottom side fixed to the bottom of the housing 101 are illustrated.

When the actuator 107 is rotated by the voice coil motor 150, an electric current flows to the flat coil 151. At this time, a driving force in the same direction indicated by arrow B in FIG. 3 within the surface along the rotating surface acts on the two coil parts 151a and 151b, which are exposed to the magnetic field from the magnet 152, according to the Fleming's left-hand rule. As a result, the driving force in the direction indicated by arrow B acts on the entire flat coil 151.

A coil supporting module 109 that holds the flat coil 151 extends toward the flat coil 151 from an end of the actuator 107 opposite to a side of the suspension 105 with the actuator shaft 108 therebetween. The flat coil 151 is held from the inside thereof by the coil supporting module 109, details of which will be described later. The coil supporting module 109 corresponds to an example of a coil supporting module in the basic mode, and a combination of the flat coil 151 and the coil supporting module 109 corresponds to an example of the coil supporting arm in the basic mode.

In the first embodiment, the coil supporting module 109 is a part integrated with the actuator 107. The term “part integrated” as used herein refers to a part obtained by integrating an arm 109a, described later, constituting the coil supporting module 109 with the actuator arm 106 constituting the actuator 107 through integral molding, bonding, or fastening.

Accordingly, the coil supporting module 109 is firmly coupled to the actuator 107. Further, the number of parts in the HDD 100 can be reduced by integrating the coil supporting module 109 with the actuator 107, which reduces manufacturing costs.

This indicates that the above basic mode is preferably modified as described below. That is, the coil supporting arm is formed of a part integrated with the actuator.

A combination of the flat coil 151 and the coil supporting module 109 of the first embodiment corresponds to an example of the coil supporting arm of this modification.

The coil supporting module 109 is made of a metal material having rigidity such as aluminum, and as illustrated in FIG. 4B, the coil supporting module 109 comprises the arm 109a coupled to the end of the actuator 107, and a support 109b extending from the arm 109a to enter into the flat coil 151 and coupled to the flat coil 151. In the flat coil 151, a part thereof on a side of the actuator 107 is arranged at a position overlapped on the arm 109a as viewed from a direction vertical to an enlarging surface (cross section) of the flat coil 151. In the first embodiment, a part of the flat coil on the actuator side is arranged at a predetermined position below the arm. It can be arranged at a predetermined position above the arm according to its design.

Further, a groove 109c is formed at a lower position of the arm 109a, as illustrated in FIG. 4B, and part of the actuator 107 in the flat coil 151 is fitted into the groove 109c.

In the coil supporting module 109, the support 109b extending from the arm 109a enters into the flat coil 151, with a gap being opened between the support 109b and an inner circumference of the flat coil 151, and the gap is filled with a resin material 110.

As illustrated in FIGS. 4A to 4C, the resin material 110 covers a base portion of the coil supporting module 109 on a side of the actuator shaft 108 including the flat coil 151 fitted into the groove 109c. The resin material 110 further enters into the groove 109c, into which the flat coil 151 is fitted, to bond and fix the flat coil 151 on an inner wall of the groove 109c.

According to such a configuration, the flat coil 151 is supported from the inside by the support 109b of the coil supporting module 109, and a part thereof is also supported by the arm 109a. The part of the flat coil 151 supported by the arm 109a is firmly supported over three faces, that is, both sides of inner and outer circumferences and a bottom face, by bonding and fixing to the inner wall of the groove 109c.

In the first embodiment, filling of the resin material 110 into the gap and covering of the base portion are performed by outsert-molding. The outsert-molding is a method in which after a part to be molded is arranged in a mold, a resin material in an uncured state is cast into the mold to cure the resin material. The coil supporting module 109 to be molded in the first embodiment is provided with a through hole 109d for increasing the coupling property with the resin material 110. Further, a through hole 110a originated from a shape of the mold is formed in the resin material 110 after being cured. These through holes 109d and 110a contribute to weight reduction of the coil supporting module 109 in a state with the flat coil 151 being held.

Thus, when an electric current flows to the flat coil 151 held by the coil supporting module 109 and the driving force in the direction of arrow B acts on the entire flat coil 151, the driving force is transmitted to the actuator 107 via the coil supporting module 109, and the actuator 107 rotates around the actuator shaft 108.

Strictly, the magnetic field applied to the flat coil 151 by the magnet 152 often comprises magnetic-field components parallel to the rotating surface. The magnetic-field components generate a driving force that vibrates the flat coil 151 in a direction twisted around a central axis of the flat coil 151 along a longitudinal direction of the actuator 107.

In the first embodiment, the flat coil 151 is supported from the inside by the coil supporting module 109. In such a configuration, the mass of the coil supporting module 109, to which the driving force generated in the flat coil 151 is transmitted, is converged at around a centerline of the flat coil 151 along the centerline of the actuator 107 in the longitudinal direction.

As a result, in the first embodiment, the moment of the coil supporting module 109 is suppressed. Accordingly, the driving force that vibrates the flat coil 151 in a twisting direction hardly vibrates the coil supporting module 109 and the actuator 107. Further, because the moment of the coil supporting module 109 is suppressed, the inertia of the coil supporting module 109 is suppressed as well. Consequently, even if the driving force vibrates the coil supporting module 109 and the actuator 107, the vibration attenuates immediately.

As described above, according to the first embodiment, the magnetic head 104 can be stably moved and positioned at high accuracy with respect to the magnetic disk 102. Moreover, suppression of vibration in the coil supporting module 109 and the actuator 107 is realized only by the configuration of the coil supporting module 109. Therefore, a separate component for stiffening the coil, for example, a coil bobbin is not required, resulting in less manufacturing cost.

Further, according to the first embodiment, because a part of the arm 109a of the coil supporting module 109 on a side of the actuator 107 supports the flat coil 151, the support of the flat coil 151 is strengthened. The support by the arm 109a is performed by fitting the flat coil 151 into the groove 109c provided in the arm 109a and bonding and fixing the flat coil 151 to the inner wall of the groove 109c with the resin material 110.

The fact that the support of the flat coil 151 is strengthened by the configuration of the arm 109a indicates that the above basic mode is preferably modified as described below. According to this modification, the coil supporting arm has an arm coupled with the actuator, and a part of the flat coil on the actuator side is arranged at a predetermined position above, below, or inside of the arm. The effect of the configuration of the arm 109a indicates that the following modification is further preferable to this modification. That is, the arm has a groove, into which part of the flat coil is fitted, and the flat coil fitted into the groove is bonded and fixed to the inner wall of the groove.

The arm 109a of the first embodiment corresponds to an example of the arm in these modifications.

In the coil supporting module 109 of the first embodiment, the support 109b extending from the arm 109a enters into the flat coil 151, with the gap being opened between the support 109b and the inner circumference of the flat coil 151. Accordingly, divergence of the mass, which affects the moment and inertia, from the centerline of the flat coil 151 can be suppressed effectively, to increase a suppression effect with respect to the moment and inertia. Further, according to the first embodiment, because the support 109b is arranged on the centerline of the flat coil 151, the mass can be effectively converged toward the centerline of the flat coil 151.

The support 109b of the coil supporting module 109 and the flat coil 151 are coupled on the inner circumference of the flat coil 151 by the resin material 110. Further, in the arm 109a, one end thereof supporting a part of the flat coil 151 on the side of the actuator 107 is buried in the resin material 110 together with the part of the flat coil 151.

The configuration of the coil supporting module 109, the high suppression effect with respect to the moment and inertia acquired by the configuration, and strengthening of the support of the flat coil 151 indicate that the above basic mode is preferably modified as described below. That is, the flat coil and the coil supporting module are coupled on the inner circumference of the flat coil by the resin material. Further, the effect of the configuration of the coil supporting module 109 also indicates that the following modification is further preferable to this modification. That is, the coil supporting arm has an arm coupled to the actuator, and one end of the arm is buried in the resin material.

The resin material of the first embodiment corresponds to an example of the resin material in these modifications. Further, the arm 109a of the first embodiment corresponds to an example of the arm in the further preferable modification described above.

Further, according to the first embodiment, the rotation range of the actuator 107 is limited as described below, to limit the movement of the magnetic head 104 along the disk surface within an information recording range in the magnetic disk 102.

In the first embodiment, this limitation is realized by a protrusion 111 protruding from the arm 109a of the coil supporting module 109 toward the bottom of the housing 101, and a pair of actuator stoppers 112 arranged vertically at the bottom of the housing 101 with the protrusion 111 therebetween in a rotation direction of the coil supporting module 109 that rotates together with the actuator 107. That is, in this configuration, the protrusion 111 that moves with the rotation of the coil supporting module 109 abuts against the actuator stoppers 112, thereby limiting the rotation range of the actuator 107.

According to such a configuration, direct collision between the coil supporting module 109 and the actuator stoppers 112, which decreases the positioning accuracy of the magnetic head 104, is avoided, and therefore the decrease of the positioning accuracy of the magnetic head can be effectively suppressed.

This indicates that the above basic mode is preferably modified as described below. According to this modification, actuator stoppers that limit the moving range of the actuator driven by the magnetic circuit are provided. Further, the coil supporting arm has a protrusion at a position abutting against the actuator stopper due to the movement of the actuator on an upper surface side or a lower surface side of the flat coil.

The actuator stoppers 112 of the first embodiment corresponds to an example of the actuator stoppers in the modification, and the abutting part 111 of the first embodiment corresponds to an example of the abutting part in the modification.

In the HDD 100 of the first embodiment, as a standby method of the magnetic head 104 when the HDD 100 is not operated, a method such that the magnetic head 104 is parked on the disk surface of the magnetic disk 102 at the time of non-operation is adopted. As a parking position thereof, an end of the information recording range in the magnetic disk 102 on the innermost circumferential side is allocated. In the HDD 100, parking of the magnetic disk 102 at the parking position is realized by a configuration described below.

Parking of the magnetic head 104 is realized by a latch magnet 113 and a magnet holding module 114 in FIG. 3. The latch magnet 113 and the magnet holding module 114 are described below.

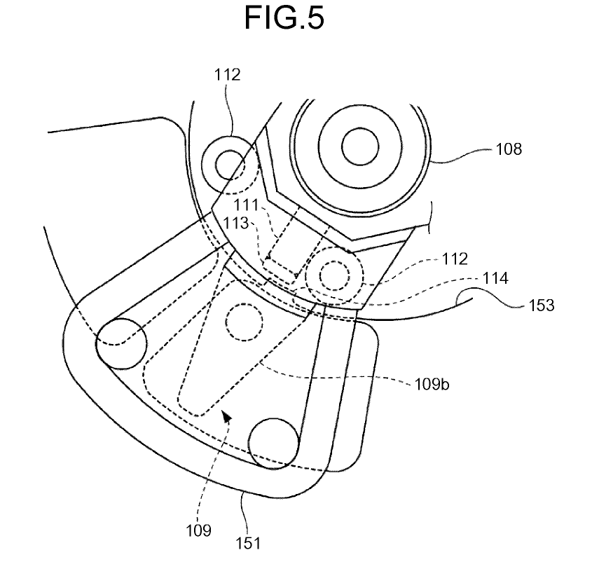

FIG. 5 is an enlarged view of the surroundings of the latch magnet 113 and the magnet holding module 114 illustrated in FIG. 3.

As illustrated in FIG. 5, the latch magnet 113 is fixed to the side of the protrusion 111 opposite to the side of the actuator shaft 108.

Meanwhile, the magnet holding module 114 is a protrusion protruding from an end face of the yoke 153 on the side of the actuator shaft 108 toward the actuator shaft 108. The magnet holding module 114 is provided near the right actuator stopper 112 in FIGS. 3 and 5 of the pair of the actuator stoppers 112. The protrusion 111 abuts against the right actuator stopper 112, when the magnetic head 104 moves to the parking position, which is the innermost circumferential end of the information recording range in the magnetic disk 102.

According to the first embodiment, when the protrusion 111 abuts against the right actuator stopper 112, the latch magnet 113 approaches the magnet holding module 114. Because the yoke 153 works as a magnetic path of the magnetic field, it is made of a material attracting the magnet. Therefore, the latch magnet 113 approaching the magnet holding module 114 is strongly attracted to the magnet holding module 114 and held.

When the HDD 100 is not operated, the magnetic disk 102 is first moved to the parking position by supplying the current to the flat coil 151. At this time, the latch magnet 113 is held by the magnet holding module 114. After the magnetic disk 102 has moved to the parking position, current supply to the flat coil 151 is stopped. However, because the latch magnet 113 is held by the magnet holding module 114, the magnetic head 104 stops at the parking position.

When the HDD 100 is activated and the magnetic head 104 is moved to a desired position, a current that generates a driving force exceeding an attracting force between the latch magnet 113 and the magnet holding module 114 is supplied to the flat coil 151.

As described above, according to the first embodiment, parking of the magnetic head 104 at the time of non-operation of the HDD 100 is realized by a simple configuration of the latch magnet 113 and the magnet holding module 114.

This indicates that the above basic mode is preferably modified as described below. That is, the coil supporting arm has a latch magnet arranged on an outer circumference of the flat coil. The actuator comprises an attracting module that faces and attracts the latch magnet when the actuator is positioned at a predetermined position within the moving range thereof.

The latch magnet 113 of the first embodiment corresponds to an example of the magnet in the modification, and the magnet holding module 114 corresponds to an example of a holding module in the modification.

Explanations of the first embodiment are as above. Next, the second embodiment is explained.

The second embodiment is basically the same as the first embodiment except for a coil supporting module different from the coil supporting module 109 of the first embodiment. Therefore, the coil supporting module, which is a different feature from the first embodiment, is mainly described below, and duplicate explanations are omitted.

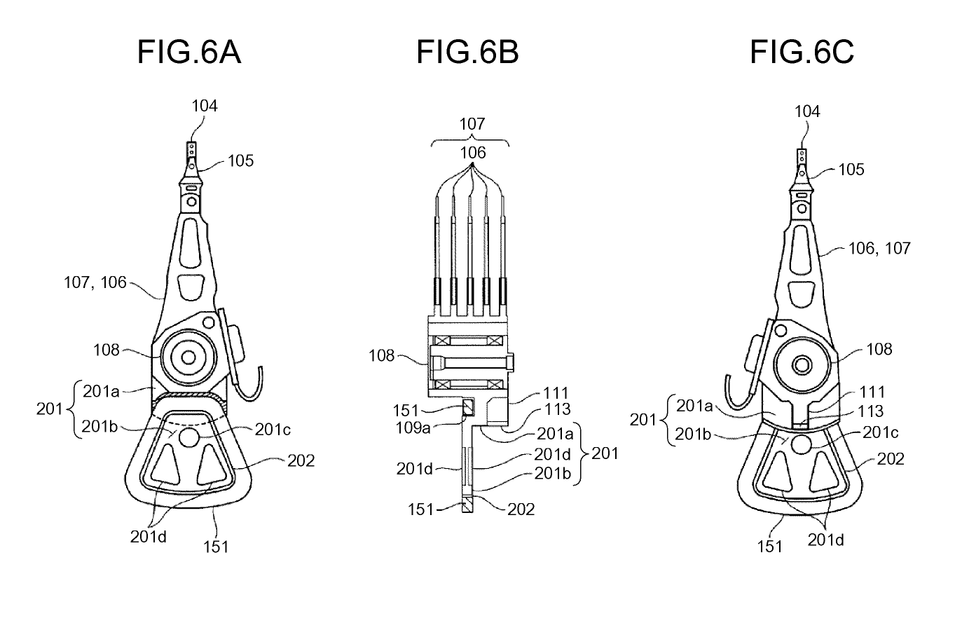

FIGS. 6A to 6C are three orthographic view of a coil supporting module 201 with the actuator 107 of the second embodiment.

In FIGS. 6A to 6C, constituent elements corresponding to those of FIGS. 4A to 4C are designated by like reference numerals.

FIG. 6A is a top view of the coil supporting module 201 and the actuator 107 of the second embodiment as viewed from the same side as in FIG. 3. FIG. 6B is a sectional view of the coil supporting module 201 and the actuator 107 in a longitudinal direction. FIG. 6C is a bottom view of the coil supporting module 201 and the actuator 107 as viewed from a side opposite to FIG. 3.

As illustrated in FIGS. 6A to 6C, the coil supporting module 201 is a part integrated with the actuator 107. The term “part integrated” as used herein refers to a part obtained by integrating an arm 201a constituting the coil supporting module 201 with the actuator arm 106 constituting the actuator 107 through integral molding, bonding, or fastening.

Further, the coil supporting module 201 comprises the arm 201a coupled to the end of the actuator 107, and a support 201b extending from the arm 201a to enter into the flat coil 151 and coupled to the flat coil 151.

In the second embodiment, the support 201b is fitted into the flat coil 151 and abuts against the inner circumference of the flat coil 151. A portion of the support 201b in contact with the inner circumference of the flat coil 151 is bonded and fixed thereto.

The coil supporting module 201 of the second embodiment having the support 201b corresponds to an example of the coil supporting module in the basic mode described above. A combination of the coil supporting module 201 and the flat coil 151 corresponds to an example of the coil supporting arm in the basic mode.

In the second embodiment, an adhesive 202 made of resin and having elasticity is used for bonding and fixing between the support 201b and the flat coil 151. Due to the elasticity of the adhesive 202, the transmission of the driving force generated in the flat coil 151 to the coil supporting module 201 can be attenuated. In the coil supporting module 201, a through hole 201c and a concave part 201d are provided to the support 201b for weight reduction.

According to the second embodiment, the coil supporting module 201 holds the flat coil 151 from the inside of the flat coil 151 as in the first embodiment. Therefore, the moment and inertia around the centerline of the flat coil 151 are suppressed.

The support 201b in the coil supporting module 201 of the second embodiment has a shape expanding away from the centerline of the flat coil 151, as compared with the arm 109a in the coil supporting module 109 of the first embodiment illustrated in FIG. 3 and the like. As to this feature, the coil supporting module 201 of the second embodiment has a suppression effect of the moment and inertia inferior to that of the coil supporting module 109 of the first embodiment. However, the coil supporting module 201 of the second embodiment also functions as a coil bobbin because the support 201b is fitted into the inner circumference of the flat coil 151. Accordingly, the rigidity of the flat coil 151 is increased. As a result, the transmission of the driving force acting on the flat coil 151 to the actuator 107 via the coil supporting module 201 is suppressed, and vibration of the actuator 107 that decreases the positioning accuracy of the magnetic head 104 is also suppressed as in the first embodiment.

This indicates that the above basic mode is preferably modified as described below. That is, the flat coil and the coil supporting module are coupled by an adhesive applied to at least part of the inner circumference of the flat coil.

The coil supporting module 201 in FIGS. 6A to 6C also corresponds to an example of the coil supporting module in this modification. The adhesive 202 corresponds to an example of the adhesive in this modification.

While, in the above embodiments, the HDD 100 provided with the magnetic disk is described as an example of the storage device, the storage device is not limited to the HDD. The storage device may be of any type as long as it moves the head with respect to a storage medium by a voice coil motor. Examples of the storage device include a storage device that optically records and reproduces information and a storage device to which a portable storage medium is externally connected.

While, in the above embodiments, a method that the magnetic disk is parked on the surface of the magnetic disk is illustrated as the standby method of the magnetic disk when the HDD is not in operation, the standby method of the magnetic head is not limited to this method. As the standby method of the magnetic head, for example, a ramp load system may be used in which the magnetic head is maintained in a standby position (ramp) provided outside the disk surface. When the ramp load system is adopted, the magnet holding module is provided near the actuator stopper, which comes in contact with the protrusion when the magnetic head moves to the ramp.

As set forth hereinabove, according to an embodiment of the invention, the influence of coil vibration of an actuator can be reduced for positioning a head with respect to a storage medium with high accuracy.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a coil supporting arm including a flat coil and a coil supporting module configured to be coupled with an inner circumference of the flat coil to support the flat coil;
an actuator configured to hold a head at one end and be provided with the coil supporting arm at another end; and
a magnetic circuit arranged near the flat coil, the magnetic circuit configured to drive the actuator.

2. The storage device of claim 1, wherein
the coil supporting arm comprises an arm extending from the coil supporting module to be coupled with the actuator, and
part of the flat coil on a side of the actuator is arranged at a predetermined position above, below, or inside the arm.

3. The storage device of claim 2, wherein
the arm comprises a groove, into which the part of the flat coil is fitted, and
the flat coil fitted into the groove is bonded and fixed to an inner wall of the groove.

4. The storage device of claim 1, wherein the coil supporting arm is formed of a part integrated with the actuator.

5. The storage device of claim 1, wherein the flat coil and the coil supporting module are configured to be coupled by an adhesive applied to at least part of the inner circumference of the flat coil.

6. The storage device of claim 1, wherein the flat coil and the coil supporting module are configured to be coupled by a resin material on the inner circumference of the flat coil.

7. The storage device of claim 6, wherein
the coil supporting arm comprises an arm extending from the coil supporting module to be coupled with the actuator, and
one end of the arm is buried in the resin material.

8. The storage device of claim 1, further comprising an actuator stopper configured to limit a moving range of the actuator driven by the magnetic circuit, wherein
the coil supporting arm comprises a protrusion at a position abutting against the actuator stopper due to movement of the actuator on an upper surface side or a lower surface side of the flat coil.

9. The storage device of claim 1, wherein
the coil supporting arm comprises a latch magnet arranged on an outer circumference of the flat coil, and
the actuator comprises an attracting module configured to face and attract the latch magnet when the actuator is located at a predetermined position within a moving range of the actuator.
